(19) United States
(12) Patent Application Publication
(10) Pub. No.: US 2005/0092039 A1
(43) Pub. Date: May 5, 2005

(54) Lock for a fastener

(76) Inventors: King Biu Mak, Hong Kong (CN); Chung Yin Ronald Mak, Hong Kong (CN); Chung Ming Mak, Hong Kong (CN)

Correspondence Address: BURNS DOANE SWECKER & MATHIS L L P, POST OFFICE BOX 1404, ALEXANDRIA, VA, 22313-1404, US

(21) Appl. No.: 10/695,818

(22) Filed: Oct. 30, 2003

(51) Int. Cl. E05B 69/00; E05B 73/00

(52) U.S. Cl. 70/58

(57) ABSTRACT

A lock for a female member of a fastening mechanism is disclosed, in which the female member is releasably engageable with a male member of the fastening mechanism, the male member having two arm members which are movable relative to each other, and the lock is movable relative to the female member between a first position in which, when the male and female members are engaged with each other, relative movement between the two arm members is allowed, thus allowing the male and female members to be disengaged from each other, and a second position in which, when the male and female members are engaged with each other, relative movement between the two arm members is denied, thus locking the male and female members against relative movement.

This invention relates to a lock, and in particular a lock suitable for use in a fastener.

### BACKGROUND OF THE INVENTION

A fastening mechanism commonly used in such article carriers as backpacks is of a type generally known as bayonet side-squeeze tension fasteners. Such a fastener includes a male component and a female component releasably attachable with each other. The male component has a first longitudinal end to which a belt may be attached. Three arms extend from a second longitudinal end of the male component. The middle arm is rigid, while the two side arms are resiliently movable between a normal position in which they extend in the same general direction as the middle arm, and a second position in which they are squeezed towards each other, and thus towards the middle arm. The female component has a first longitudinal end to which a belt may be attached. A second longitudinal end of the female component is open, and with an internal width slightly smaller than the widest outer width of the two side arms of the male component. Part of each of the two lateral sides of the female component is also open, and communicates with the open second longitudinal end.

When the two components are to be engaged with each other, the two side arms are squeezed towards each other, e.g. when forced by the inner walls of the two lateral sides of the female component. The male component may then be inserted into the female component, until the side arms are fully received into the female component. In this position, the side arms are next to the lateral openings of the female component, and the side arms are allowed to return to their normal position under their resilience, to thereby secure the two components against movement relative to each other.

If the two components are to be disengaged from each other, the two side arms are squeezed towards each other, e.g. by a user, whereby the male component may be retrieved from the female component, until they are clear of each other.

Such a fastening mechanism is easy to operate and manufacture, and has thus been widely used in many appliances. However, no locking mechanism has been provided for such a fastening mechanism, so that security problem exists with the use of such a fastening mechanism.

It is thus an object to provide a locking mechanism suitable for use in such a fastening mechanism, or at least to provide a useful option to the trade and public.

It is a further object of the present invention to provide a locking mechanism which allows at least two components of the locking mechanism to be engaged with each other in different orientations for effecting locking of the fastening mechanism, so as to allow more versatility.

It is a yet further object of the present invention to provide a locking mechanism which allows a user to set the number or number combination to open the lock.

Such and other objects of the present invention will be apparent from the ensuing discussion.

### SUMMARY OF THE INVENTION

According to a first aspect of the present invention, there is provided a lock adapted to be carried by a female member of a fastening mechanism, wherein said female member is adapted to be releasably engaged with at least one male member of said fastening mechanism, said male member having at least two arm members which are movable relative to each other, wherein said lock is movable relative to said female member between a first position in which, when said male and female members are engaged with each other, relative movement between said two arm members is allowed, and a second position in which, when said male and female members are engaged with each other, relative movement between said two arm members is denied.

According to a second aspect of the present invention, there is provided a female member for a fastening mechanism, said female member including at least one lock, wherein said female member is adapted to be releasably engaged with at least one male member of said fastening mechanism, said male member having at least two arm members which are movable relative to each other, wherein said lock is movable relative to said female member between a first position in which, when said male and female members are engaged with each other, relative movement between said two arm members is allowed, and a second position in which, when said male and female members are engaged with each other, relative movement between said two arm members is denied.

According to a third aspect of the present invention, there is provided a fastening mechanism including a male member and a female member which are releasably engageable with each other, wherein said female member includes at least one lock, said male member having at least two arm members which are movable relative to each other, wherein said lock is movable relative to said female member between a first position in which, when said male and female members are engaged with each other, relative movement between said two arm members is allowed, and a second position in which, when said male and female members are engaged with each other, relative movement between said two arm members is denied.

### BRIEF DESCRIPTION OF THE DRAWINGS

Preferred embodiments of the present invention will now be described, by way of example only, with reference to the accompanying drawings, in which:

FIG. 1A is a top view of a lock according to the present invention;

FIG. 1B is a rear view of the lock shown in FIG. 1A;

FIG. 1C is a front view of the lock shown in FIG. 1A;

FIG. 1D is a left side view of the lock shown in FIG. 1A;

FIG. 1E is a right side view of the lock shown in FIG. 1A;

FIG. 1F is a bottom view of the lock shown in FIG. 1A;

FIG. 2 is an exploded view of the lock shown in FIG. 1A;

FIG. 3 is a further exploded view of the lock shown in FIG. 1A;

FIG. 4A shows the lock shown in FIG. 1A in a first orientation;

FIG. 4B shows the lock shown in FIG. 1A in a second orientation;

FIG. 4C shows the lock shown in FIG. 1A in a third orientation;

FIG. 5 shows a male component of a fastening mechanism;

FIG. 6 shows a female component of a fastening mechanism installed with two locks shown in FIG. 1A in a first relative orientation;

FIG. 7A shows the female component shown in FIG. 6 engaged with the male component shown in FIG. 5, in which the male and female components are disengageable from each other;

FIG. 7B shows the female component shown in FIG. 6 engaged with the male component shown in FIG. 5, in which the male and female components are locked against movement relative to each other;

FIG. 8A shows a female component of a fastening mechanism installed with the lock shown in FIG. 1A in a second relative orientation;

FIG. 8B is a side view of the female component shown in FIG. 8A;

FIG. 9A shows the female component shown in FIG. 8A engaged with the male component shown in FIG. 5, in which the male and female components are disengageable from each other;

FIG. 9B shows the female component shown in FIG. 8A engaged with the male component shown in FIG. 5, in which the male and female components are locked against movement relative to each other;

FIG. 10 shows a female component of a fastening mechanism installed with a lock shown in FIG. 1A in a third relative orientation;

FIG. 11A shows the female component shown in FIG. 10 engaged with the male component shown in FIG. 5, in which the male and female components are disengageable from each other;

FIG. 11B shows the female component shown in FIG. 10 engaged with the male component shown in FIG. 5, in which the male and female components are locked against movement relative to each other;

FIG. 12A shows two locks shown in FIG. 1A installed with a female component of a fastening mechanism in a first manner;

FIG. 12B is a rear view of the female component shown in FIG. 12A;

FIG. 12C is a front view of the female component shown in FIG. 12A;

FIG. 12D is a right side view of the female component shown in FIG. 12A;

FIG. 13A shows two locks shown in FIG. 1A installed with a female component of a fastening mechanism in a second manner;

FIG. 13B is a rear view of the female component shown in FIG. 13A;

FIG. 13C is a front view of the female component shown in FIG. 13A;

FIG. 13D is a side view of the female component shown in FIG. 13A;

FIG. 14A shows four locks shown in FIG. 1A installed with a female component of a fastening mechanism;

FIG. 14B is a rear view of the female component shown in FIG. 14A; and

FIG. 14C is a front view of the female component shown in FIG. 14A.

### DETAILED DESCRIPTION OF THE PREFERRED EMBODIMENTS

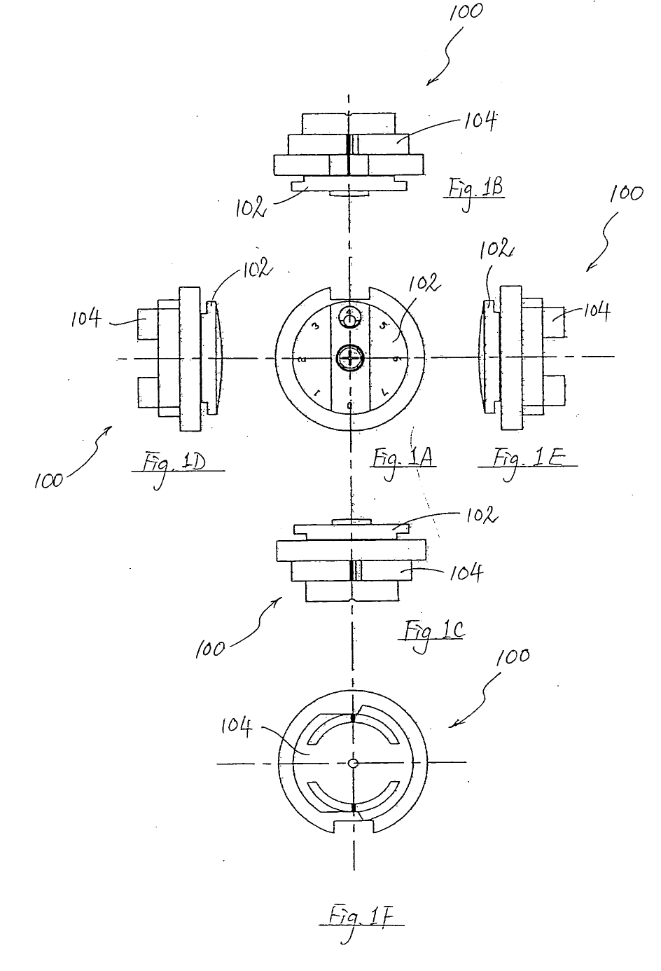

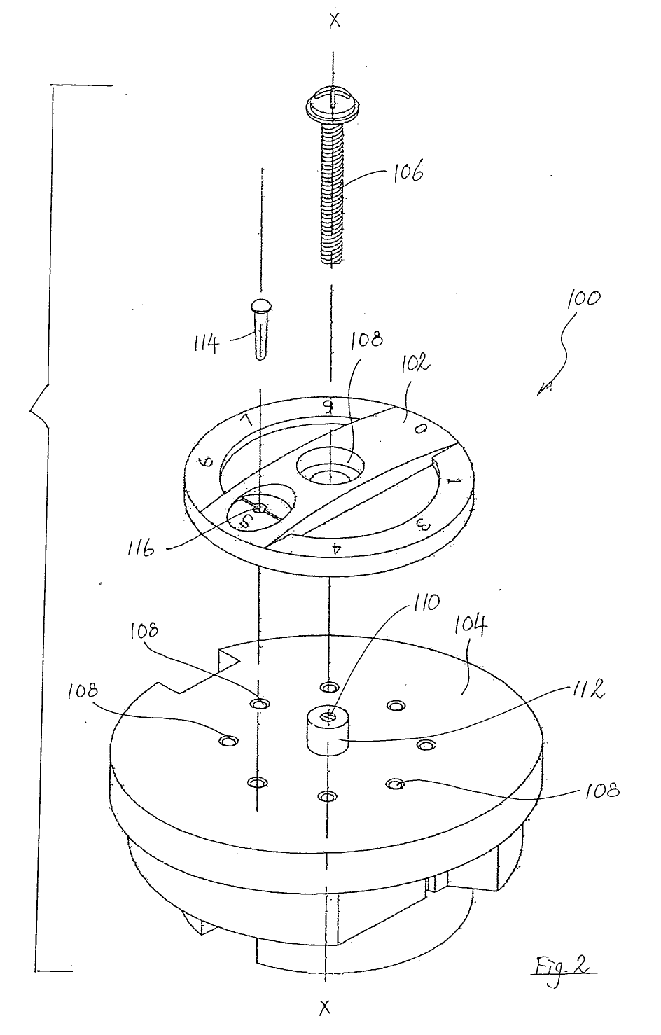

FIGS. 1A to 1F show various views of a lock according to the present invention, and generally designated as 100. The lock 100 includes a disc 102 and a body 104, which are releasably engaged with each other, in a manner to be discussed below.

As shown in FIG. 2, the disc 102 is marked with a number of numerals along its periphery. A screw 106 is receivable through a hole 108 of the disc 102 and an internally threaded hole 110 of a post 112 extending from a major surface of the body 104, to secure the disc 102 to the body 104. By way of this arrangement, the disc 102 is rotatable relative to the body 104 about a longitudinal axis X-X of the body 104. A pin 114 is receivable through a hole 116 of the disc 102. The pin 114 is also receivable in a number of holes 118 disposed on the major surface of the body 104. It is thus possible to secure the disc 102 to the body 104 in a number of different configurations, according to the wish of the user. This allows a user to set the number or number combination for which the lock may be unlocked, in a manner to be discussed below.

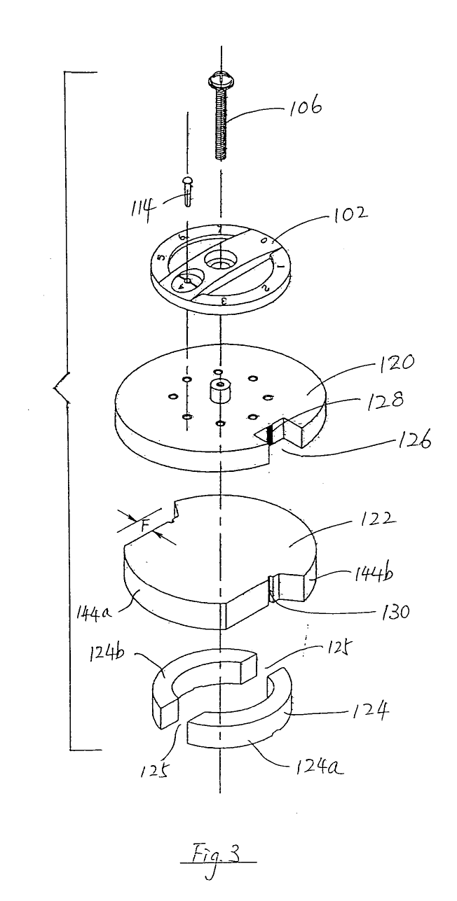

While the body 104 is formed of an integral whole, for the sake of easy understanding of the present invention, the body 104 is shown in FIG. 3 as being broken up into its component layers. The body 104 includes a first lock layer 120, a second lock layer 122 and a third lock layer 124. The first layer 120 is in the form of a circular plate with a generally rectangular recess 126. On a surface of the recess 126 is a marked position 128, which serves to indicate the unlocked position when the first layer 120 serves as the locking portion, again in a manner to be discussed below. As to the second layer 122, such is a generally circular plate with two lateral cut-out regions. There is provided a notched portion 130 in each cut-out region, which serves to indicate the unlocked position when this second layer 122 serves as the locking portion. The third layer 124 includes two disjointed arc portions 124a, 124b separated from each other by two gap regions 125.

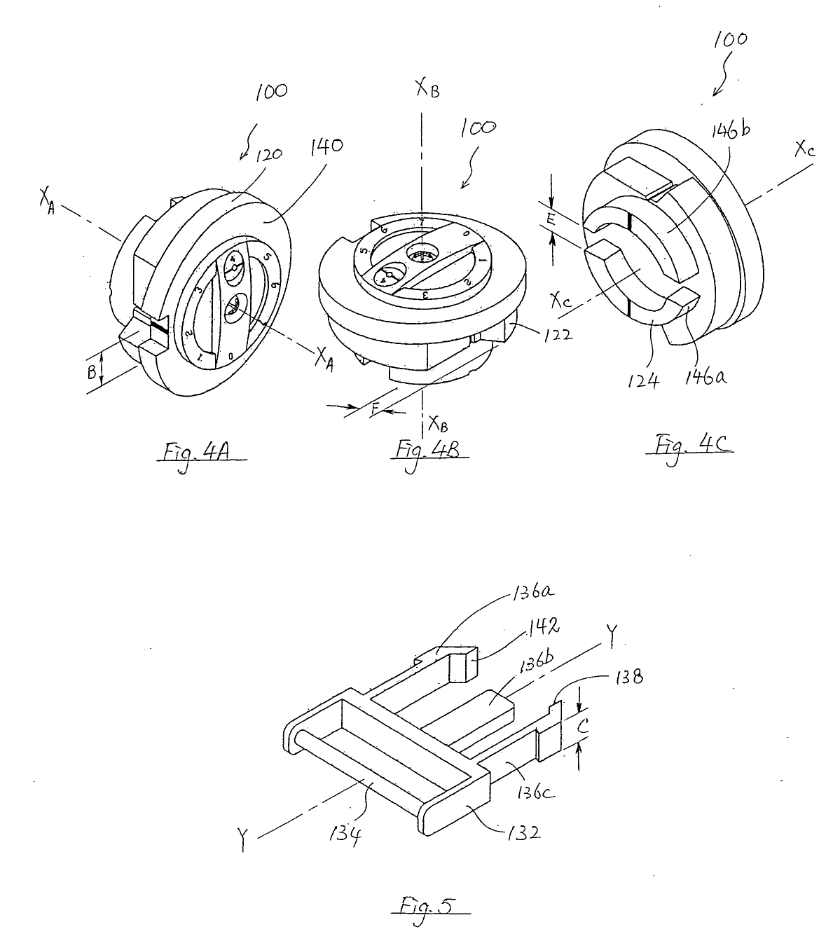

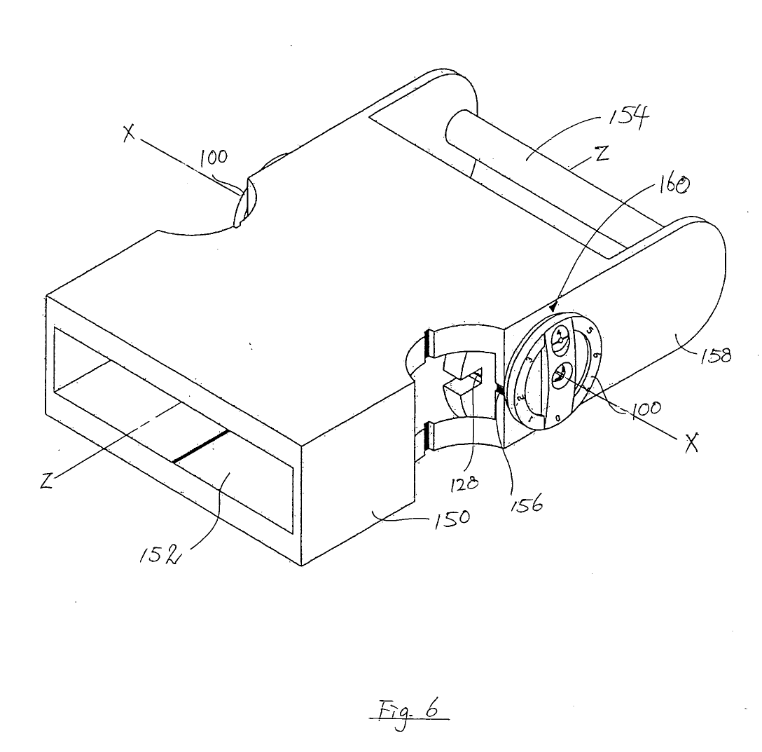

FIGS. 4A to 5 show different ways in which a male component 132 of a fastener (not shown) may be engaged with the lock 100. As shown in FIG. 5, the male component 132 includes, at one of its ends, a rod 134 onto which a belt (not shown) may be secured. Three arms 136a, 136b, 136c extend from another end of the male component 132. The middle arm 136b is rigid, while the two side arms 136a, 136c are resiliently movable between a normal position, as shown in FIG. 5, in which they extend in the same direction as the middle arm 136b, and a second position in which they are squeezed towards each other, and thus towards the middle arm 136b.

In the case where the lock 100 and the male component 132 are oriented relative to each other as shown in FIGS. 4A and 5, the male component 132 can engage with the first layer 120 of the body 104 for locking and unlocking purpose. It can be seen that, in this relative orientation, the longitudinal axis X_{A}-X_{A} of the lock 100 is perpendicular to the longitudinal axis Y-Y of the male component 132. In this connection, the width B of the recess 126 of the first layer 120 is slightly larger than the thickness C of the side arm 136c. In particular, the male component 132 and the lock 100 will be arranged such that, when the male component 132 is engaged with the lock 100, an inner surface 138 of the side arm 136c will, in its normal position, abut an outer surface 140 of the first layer 120. In this position, the side arm 136c cannot be squeezed towards the middle arm 136, thus preventing unlocking of the male component 132 from the lock 100.

By rotating the lock 100 relative to the male component 132 and about the axis X_{A}-X_{A}, the recess 126 of the first layer 120 can be moved adjacent the inner surface 138 of the side arm 136c. As the thickness C of the side arm 136c is slightly narrower than the width B of the recess 126, the side arm 136c may then be bent inwardly, i.e. squeezed into the recess 126 and towards the middle arm 136b, thus allowing the male component 132 to be unlocked from the female member (not shown) installed with the lock 100. For better performance, and as will be further discussed below, a further lock 100 may be provided, in a tail to tail manner with the original lock 100, so that an inner surface 142 of the side arm 136a normally abuts an outer surface of a first layer 120 of the second lock 100.

The lock 100 and the male component 132 may alternatively be oriented relative to each other as shown in FIGS. 4B and 5 for releasable inter-engagement. It can be seen that, in this orientation, although the longitudinal axis X_{B}-X_{B} of the lock 100 is also perpendicular to the longitudinal axis Y-Y of the male component 132, the longitudinal X_{B}-X_{B} in FIG. 4B is perpendicular to the orientation of the longitudinal axis X_{A}-X_{A} in FIG. 4A. In the situation as shown in FIGS. 4B and 5, the male component 132 will engage with the second layer 122 of the body 104 for locking and unlocking purpose. Normally, when the lock 100 and the male component 132 are engaged in the relative orientation as shown in FIGS. 4B and 5, the inner surfaces 138, 142 of the side arms 136c, 136a will abut curved outer surfaces 144a, 144b (see FIG. 3) of the second layer 122. In this position, the side arms 136a, 136c will be prevented from being squeezed towards the middle arm 136, thus preventing unlocking of the male component 132 from the lock 100.

By rotating the lock 100 relative to the male component 132 and about the axis X_{B}-X_{B}, the lateral cut-out regions of the second layer 122 can be moved adjacent the inner surfaces 138, 142 of the side arms 136c, 136a. In this configuration, the side arms 136c, 136a may be bent inwardly, i.e. squeezed into the cut-out regions and towards the middle arm 136b. The width F of the cut-out regions is wide enough to allow the side arms 136c, 136a to be squeezed towards each other to an extent sufficient to allow the male component 132 to be unlocked from the female member (not shown) installed with the lock 100.

The lock 100 and the male component 132 may also be oriented relative to each other as shown in FIGS. 4C and 5 for releasable inter-engagement. It can be seen that, in this relative orientation, the longitudinal axis X_{C}-X_{C} of the lock 100 is parallel to the longitudinal axis Y-Y of the male component 132. In this configuration, the male component 132 will engage with the third layer 124 of the body 104 for locking and unlocking purpose. Normally, when the lock 100 and the male component 132 are engaged in the relative orientation as shown in FIGS. 4C and 5, the inner surfaces 138, 142 of the side arms 136c, 136a will abut curved outer surfaces 146a, 146b of the third layer 124. In this position, the side arms 136a, 136c will be prevented from being squeezed towards the middle arm 136, thus preventing unlocking of the male component 132 from the lock 100.

By rotating the lock 100 relative to the male component 132 and about the axis X_{C}-X_{C}, the gap regions 125 of the third layer 124 can be moved adjacent the inner surfaces 138, 142 of the side arms 136c, 136a. In this configuration, as the width E of the gap regions 125 between the arc portions 124a, 124b is slightly larger than the thickness C of the side arms 136c, 136a, the side arms 136c, 136a may be bent inwardly, i.e. squeezed into the gap regions 125 and towards the middle arm 136b, thus allowing the male component 132 to be unlocked from the female member (not shown) installed with the lock 100.

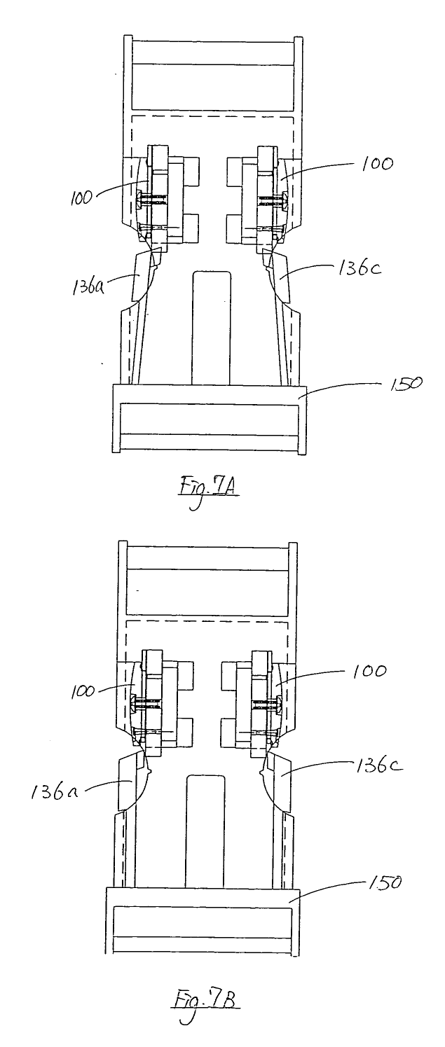

A female component 150 of a fastening mechanism may be installed with two locks 100 according to the present invention, as shown in FIGS. 6 to 7B. In this construction, the longitudinal axis X-X of the lock 100 is perpendicular to the longitudinal axis Z-Z of the female component 150. The female component 150 has an open longitudinal end 152 for receiving the male component 132. Another longitudinal end of the female component 150 is provided with a rod 154 for engagement with a belt (not shown). In this construction, when the male component 132 is inserted into the open end 152, the side arms 136c, 136a will engage with the first layer 120 of the lock 100 for locking and unlocking function. When the lock 100 is moved to the unlockable position, as shown in FIG. 7A, the marked position 128 will be in line with a marked region 156 on a side of the female component 150, thus signifying that the male component 132 may now be inserted into the female component 150 for inter-engagement. Of course, when the male component 132 and the female component 150 are engaged with each other, the marked position 128 of the lock 100 may not be perceivable from the outside, thus hindering unauthorized unlocking. It should also be understood that the male component 132 may only be inserted into and thus engaged with the female component 150 when the locks 100 are in the unlockable position, as shown in FIG. 6. Thus, the unlockable position of the lock 100 is also the engageable position in which the male component 132 may be engaged with the female component 150, and any locked position of the lock 100 is also an un-engageable position in which the male component 132 and the female component 150 cannot be properly engaged with each other.

On a side surface 158 of the female component 150 is a marker 160 in the form of an arrow to assist in ascertaining the orientation of the lock 100 relative to the female component 150. As shown in FIG. 6, the lock 100 is in an unlockable position when the numeral 4 is next to the marker 160. This thus acts as a number for allowing unlocking of the male component 132 and the female component 150. The user may disengage the disc 102 from the body 104 of the lock and re-engage the disc 102 with the body 104 such that a different number is next to the marker 160 in this unlockable position. The user may thus set his/her own unlocking number. As the female component 150 is installed with two locks 100, the user may set an unlocking number combination.

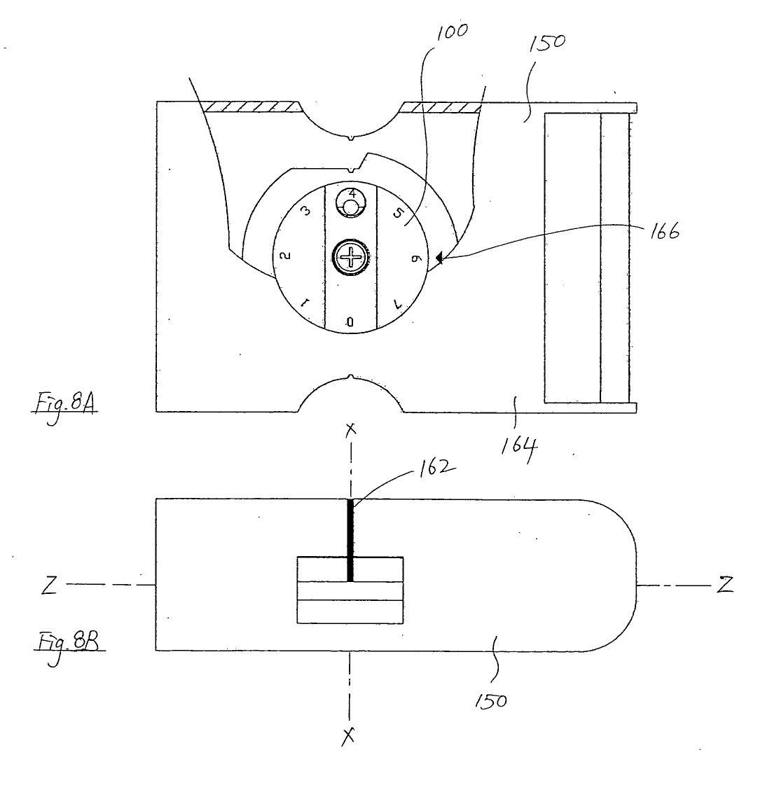

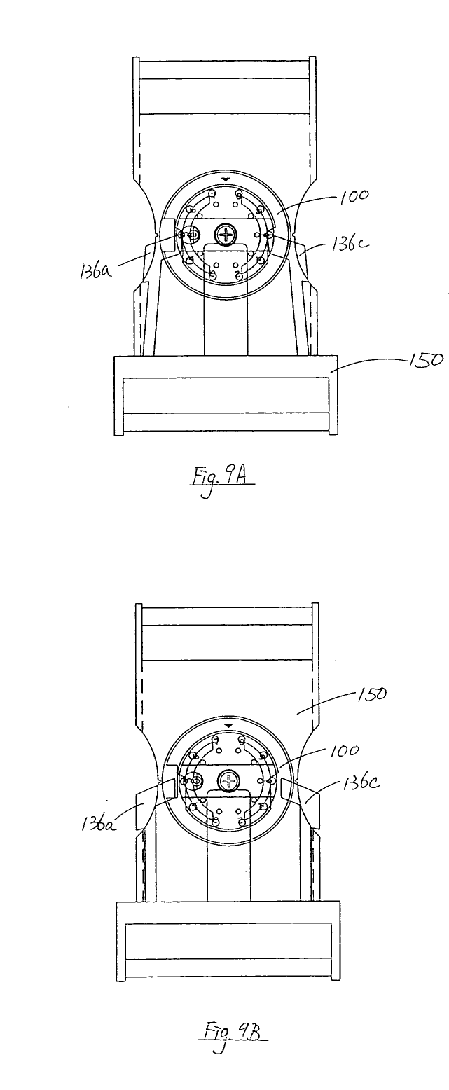

A female component 150 of a fastening mechanism may instead be installed with a lock 100 according to the present invention, as shown in FIGS. 8A to 9B. In this construction, the longitudinal axis X-X of the lock 100 is also perpendicular to the longitudinal axis Z-Z of the female component 150. In particular, in this construction, when the male component 132 is inserted into the female component 150, the side arms 136c, 136a will engage with the second layer 122 of the lock 100 for locking and unlocking function. When the lock 100 is moved to the unlockable position, the notched position 130 will be in line with a marked region 162 on a respective side of the female component 150, thus signifying that the male component 132 may now be inserted into the female component 150 for inter-engagement. Of course, when the male component 132 and the female component 150 are engaged with each other, the notched position 130 of the lock 100 may not be perceivable from the outside, thus hindering unauthorized unlocking.

On a top surface 164 of the female component 150 is a marker 166 in the form of an arrow to assist in ascertaining the orientation of the lock 100 relative to the female component 150. As shown in FIG. 8A, the lock 100 is in an unlockable position when the numeral 6 is next to the marker 166. This thus acts as a number for allowing unlocking of the male component 132 and the female component 150. The user may disengage the disc 102 from the body 104 of the lock and re-engage the disc 102 with the body 104 such that a different number is next to the marker 166 in this unlockable position. The user may thus set his/her own unlocking number.

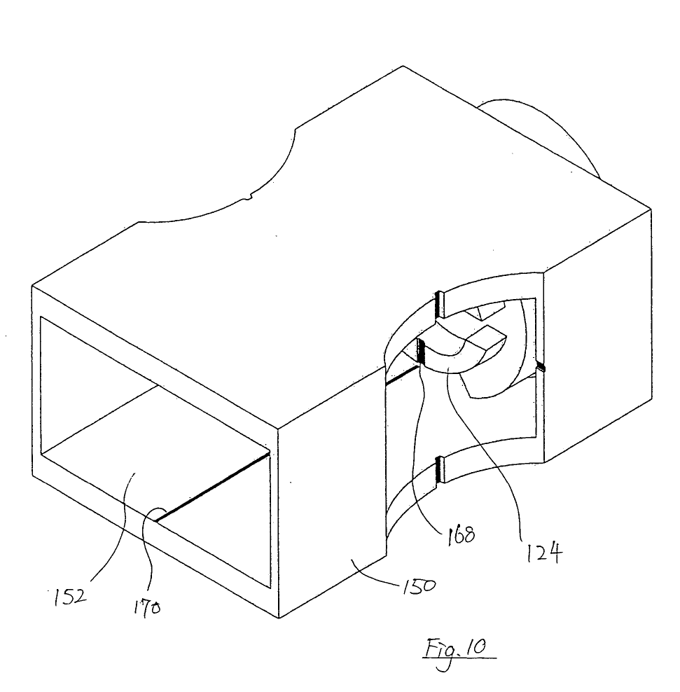

A female component 150 of a fastening mechanism may be installed with two locks 100 according to the present invention, as shown in FIGS. 10 to 11B. In this construction, the longitudinal axis X-X of the lock 100 is parallel to the longitudinal axis Z-Z of the female component 150. The female component 150 has an open longitudinal end 152 for receiving the male component 132. In this construction, when the male component 132 is inserted into the open end 152, the side arms 136c, 136a will engage with the third layer 124 of the lock 100 for locking and unlocking function. When the lock 100 is moved to the unlockable position, as shown in FIG. 11A, a marked position 168 of the third layer 124 will be in line with a line 170 marked on an inside lower surface of the female component 150, thus signifying that the male component 132 may now be inserted into the female component 150 for inter-engagement. Of course, when the male component 132 and the female component 150 are engaged with each other, the marked position 168 of the lock 100 may not be perceivable from the outside, thus hindering unauthorized unlocking.

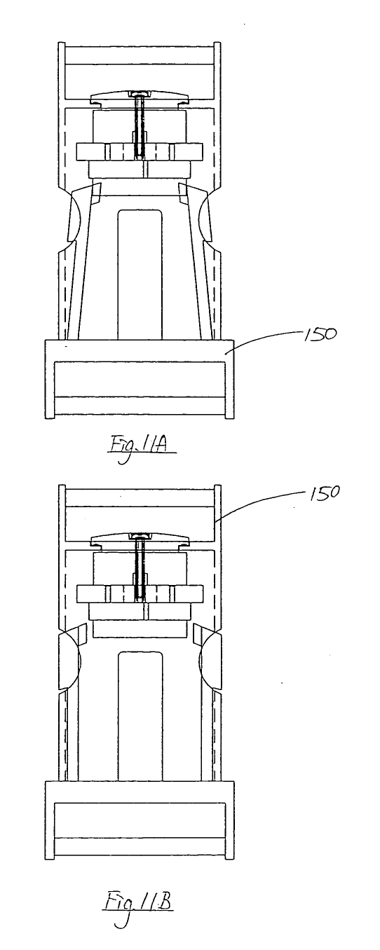

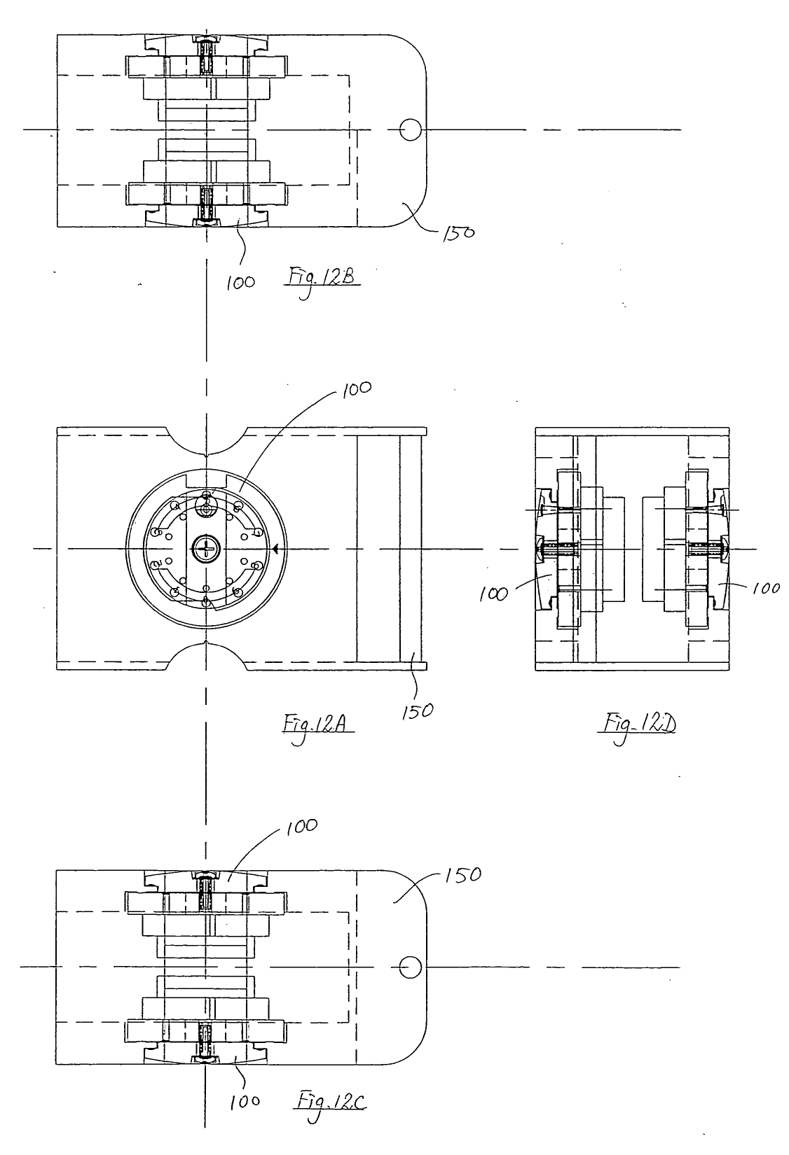

Further modifications may be made to the foregoing arrangements. As shown in FIGS. 12A to 12D, modifications may be made to the arrangement shown in FIGS. 8A to 8B, by installing two locks 100 with a female component 150, in a tail to tail manner. By way of such an arrangement, two male components 132 may be releasably engageable with a single female component 150, and the male components 132 and the female component 150 can only be fully detached when both the locks 100 are in the unlockable positions.

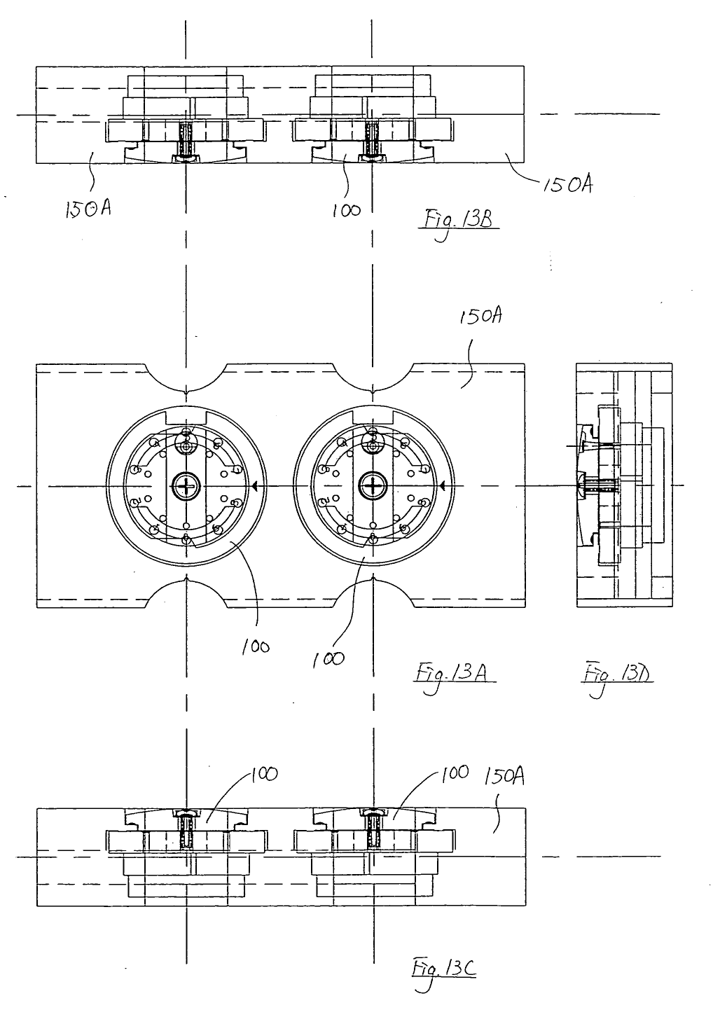

A further modified arrangement is shown in FIGS. 13A to 13D, in which a female component 150A is installed with two locks 100, in a side by side manner. It can be seen that the female components 150A has two open longitudinal ends, to each of which a male component 132 may be inserted.

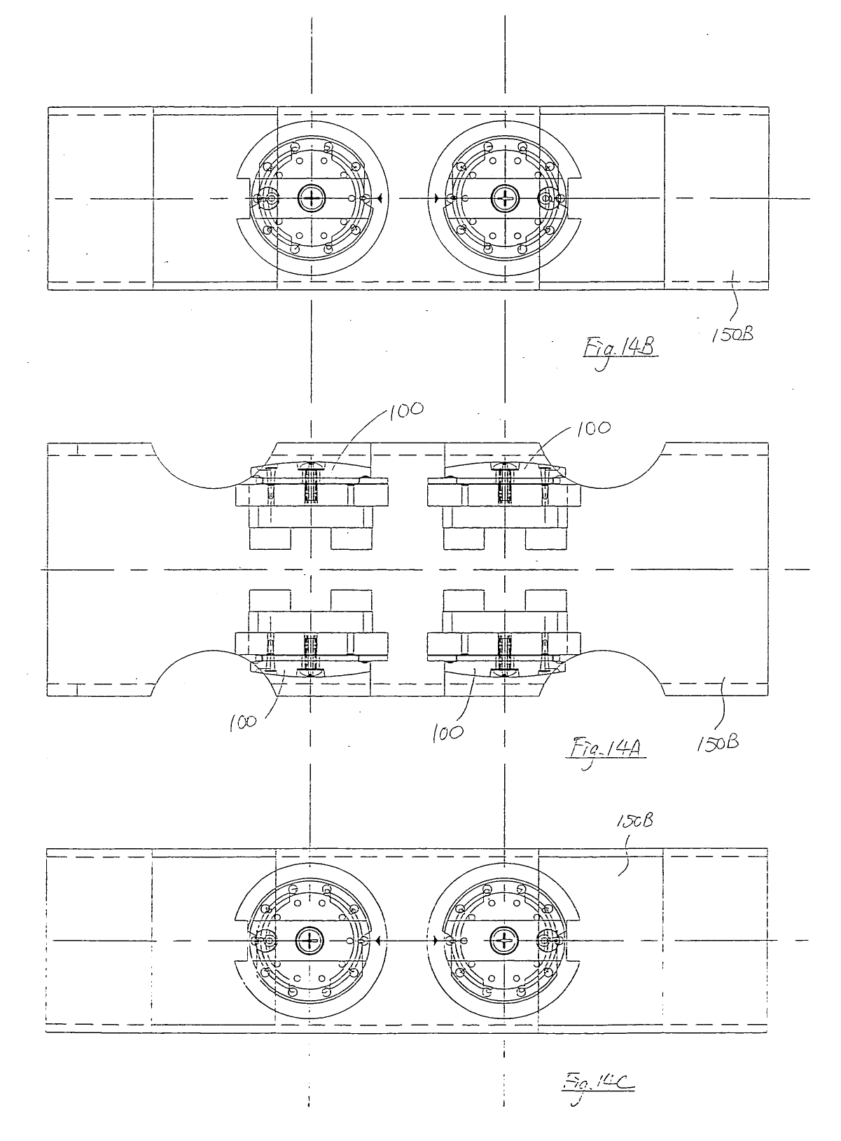

A yet further modified arrangement is shown in FIGS. 14A to 14C, in which a female component 150B is installed with a total of four locks 100. The female components 150B has two open longitudinal ends, to each of which a male component 132 may be inserted.

It should be understood that the above only illustrates examples whereby the present invention may be carried out, and that various modifications and/or alterations may be made thereto without departing from the spirit of the invention.

It should also be understood that certain features of the invention, which are, for clarity, described in the context of separate embodiments, may be provided in combination in a single embodiment. Conversely, various features of the invention which are, for brevity, described in the context of a single embodiment, may also be provided separately or in any appropriate sub-combinations.

1. A lock adapted to be carried by a female member of a fastening mechanism, wherein said female member is adapted to be releasably engaged with at least one male member of said fastening mechanism, said male member having at least two arm members which are movable relative to each other, wherein said lock is movable relative to said female member between a first position in which, when said male and female members are engaged with each other, relative movement between said two arm members is allowed, and a second position in which, when said male and female members are engaged with each other, relative movement between said two arm members is denied.

2. A lock according to claim 1 wherein when said male member is engaged with said second member, and when said lock is in said first position, said male and female members are releasable from each other.

3. A lock according to claim 1 wherein when said male member is engaged with said second member, and when said lock is in said second position, said male and female members are locked against movement relative to each other.

4. A lock according to claim 3 wherein when said lock is in said second position, said male and female members are un-engageable with each other.

5. A lock according to claim 1 wherein said lock is engageable with said female member in a first orientation wherein a longitudinal axis of said lock is substantially perpendicular to a longitudinal axis of said female member.

6. A lock according to claim 5 wherein when said lock is engaged with said female member in said first orientation, said arm members of said male member are engageable with a first locking part of said lock.

7. A lock according to claim 6 wherein said first locking part is in the shape of a substantially circular plate with a recess.

8. A lock according to claim 1 wherein said lock is engageable with said female member in a second orientation wherein a longitudinal axis of said lock is substantially parallel to a longitudinal axis of said female member.

9. A lock according to claim 8 wherein when said lock is engaged with said female member in said second orientation, said arm members of said male member are engageable with a second locking part of said lock.

10. A lock according to claim 9 wherein said second locking part includes at least two separate curved members.

11. A lock according to claim 1 wherein said lock is engageable with said female member in a third orientation wherein a longitudinal axis of said lock is substantially perpendicular to a longitudinal axis of said female member, and is substantially perpendicular to the longitudinal axis of said lock when in said first orientation.

12. A lock according to claim 11 wherein when said lock is engaged with said female member in said third orientation, said arm members of said male member are engageable with a third locking part of said lock.

13. A lock according to claim 1, further including an indicator for indicating the relative position between said lock and said female member.

14. A lock according to claim 13 wherein said indicator is movable relative to a body of said lock.

15. A female member for a fastening mechanism, said female member including at least one lock according to claim 1.

16. A female member for a fastening mechanism, said female member including a lock according to claim 13, wherein said indicator is marked with at least a first and a second position marker, wherein when said first position marker is adjacent to a pre-determined position of said female member, relative movement between said two arm members is allowed, and when said second position marker is adjacent to said pre-determined position of said female member, relative movement between said two arm members is denied.

17. A female member according to claim 15, further including a plurality of said locks.

18. A female member according to claim 17 wherein the longitudinal axes of said plurality of locks are substantially parallel to each other.

19. A female member according to claim 17 wherein the longitudinal axes of said plurality of locks substantially coincide with each other.

20. A female member according to claim 15 wherein said lock is rotatable relative to said female member.

21. A female member according to claim 15 wherein said female member is releasably engageable with at least two male members.

22. A fastening mechanism including a male member and a female member which are releasably engageable with each other, wherein said female member includes at least one lock according to claim 1.

23. A fastening mechanism according to claim 22 wherein said female member includes a plurality of said locks.
